(19) United States
(12) Patent Application Publication
(10) Pub. No.: US 2014/0312235 A1
(43) Pub. Date: Oct. 23, 2014

(54) METHOD OF DETECTING NUCLEAR RADIATION OR RADIOACTIVE MATERIAL IN A CONTAINER

(71) Applicants: Charles Stephen HARDEN, Bel Air, MD (US); Joseph Childs HARDEN, Yemassee, SC (US)

(72) Inventors: Charles Stephen HARDEN, Bel Air, MD (US); Joseph Childs HARDEN, Yemassee, SC (US)

(21) Appl. No.: 13/854,488

(22) Filed: Apr. 1, 2013

Related U.S. Application Data
(60) Provisional application No. 61/686,072, filed on Mar. 30, 2012.

(51) Int. Cl. G01V 5/00; G06Q 10/08; G01T 1/167

(52) U.S. Cl. CPC G01V 5/0075; G01T 1/167; G06Q 10/0838
USPC 250/358.1

(57) ABSTRACT

A method of analysis for detecting and reporting the presence of low levels of ionizing radiation in spaces such as cargo shipping containers. Radiation detectors are placed inside the containers and the method is invokable while the containers are in transit. The difference between radiation emanating from inside the container and radiation emanating from outside the container is determined to detect and identify low levels of radiation. The detected and identified radiation is comparable with the container manifest to determine whether the radiation is from sources identified in the manifest or is likely to be contraband.

### BACKGROUND

The possibility of concealing chemical, biological, radiological and/or nuclear (CBRN) weapons of mass destruction (WMD) in cargo shipping containers and/or other secure spaces crossing international borders is a potential interruption to the free flow of commerce.

In addition, many kinds of radiation imaging modes such as transmission imaging, multi-viewing imaging, and other imaging methods have been proposed or are being developed. The various imaging methods employ scanning systems physically located outside the container. In addition, such scanning or imaging methods are time consuming. Scanning and imaging methods are subject to false alarms because of the extremely low level of material representing presence of CBRN WMD material and/or other contraband. Time consuming scanning and imaging methods and high levels of false alarms are detrimental to the safe, timely and efficient transmission of cargo across international borders. The current inspection devices cannot meet this need.

Radiation detectors and distributed radiation detectors located inside shipping containers have been proposed. These detection methods do not account for radiation originating from outside of the container, i.e., background radiation, that contributes to the radiation detected by the radiation detectors of the prior art. Failure to account for radiation originating from outside of the container can lead to false conclusions with respect to the source of radiation located inside the container that might represent contraband.

### BRIEF DESCRIPTION OF DRAWINGS

One or more embodiments are illustrated by way of example, and not by limitation, in the figures of the accompanying drawings, incorporated herein in their entirety and wherein elements having the same reference numeral designations represent like elements throughout and wherein:

FIG. 1A is a high level block diagram of a container comprising a detection system according to an embodiment;

FIG. 1B is a high level block diagram of a container comprising a detection system according to another embodiment; and

FIG. 2 is a high level functional block diagram of a computer system useable in conjunction with an embodiment.

### DETAILED DESCRIPTION

Nominal background radiation level from sources outside of a shipping container are on the order of 3-5 micro Radiation/hour (microRad/hr) at sea level, whereas inside the container the radiation level could be increased by a factor of two or more due to the presence of radioactive material. Reliable detection of such a low level of radiation intensity inside the container is accomplished if the variation in radiation intensity outside the container, i.e., background, is monitored and incorporated into the final measurement of radiation inside the container.

In at least some embodiments, reliable detection of low level radiation intensity is only able to be accomplished if the variation in radiation intensity outside the container is monitored and incorporated into the final radiation measurement inside the container. This is because radiation backgrounds differ at various locations throughout the world and even over relatively short distances. Regardless of the source of the background radiation level changes, background radiation is measured and compensated for in the overall measurement of the radiation level inside the container.

A scintillation counter radiation detection system has a higher probability of achieving the requirements for this type measurement as compared to other radiation detection systems. Scintillation systems are approximately 10 times more sensitive than other radiation detection systems and are relatively inexpensive for broad scale distribution. Additionally in at least some embodiments, scintillation counters use comparatively little electrical power and require less maintenance. In at least some embodiments, scintillation counters are reliable and well suited for long-term operation. A type of scintillation counter radiation detection system is the RadSeeker available from Smiths Detection of Edgewood, Md. The radiation detection technology used in accordance with one or more embodiments is not limited to scintillation counters.

In at least one embodiment, the radiation detection technology comprises only scintillation counters. In at least one embodiment, the radiation detection technology comprises at least two scintillation counters. In at least one other embodiment, the radiation detection technology comprises at least one scintillation counter. In at least one other embodiment, the radiation detection technology comprises at least one scintillation counter and one additional different type of radiation detection technology.

One or more embodiments of the present disclosure relate to a method of detecting and reporting ionizing radiation emissions from radioactive contraband, for example, “dirty bombs,” concealed in confined spaces of shipping containers, other cargo containers and/or other secure spaces. In at least one embodiment, radiation detection and analysis occurs while the containers are in transit from the time that items are placed into the containers and sealed, to the time period during which the containers move through inspection chokepoints, through the shipping time period of the containers, and to the time period during which the containers are inspected at national border crossing points. During the transit time period, radiation levels are measured continually, in at least some embodiments. In at least some embodiments, radiation levels are measured periodically. In at least some embodiments, radiation levels are measured at randomly determined times.

Use of the term “containers” refers to shipping containers (including confined spaces in such shipping containers), other cargo containers and/or other secure spaces. The terms “ionizing radiation,” “radioactivity,” “nuclear radiation,” are interchangeable and refer to particle or electromagnetic radiation emissions sufficient to cause an electron to be ejected from an atom or molecule thus producing an ion—common types of ionizing radiation, radioactivity or nuclear radiation are alpha particles, beta particles, gamma rays, cosmic rays, X-rays, and ultraviolet rays. Radiation detectors include scintillation counters, semiconductor detectors, gaseous ionization detectors and/or similar devices used to detect, track, and/or identify ionizing radiation, radioactivity, or nuclear radiation.

One or more nuclear radiation detectors based on the present disclosure are able to be interfaced with a chemical detection device based on a similar method for in-transit determination of chemical contraband, decaying animal and vegetable matter, and concealed humans in cargo shipping containers and/or other secure spaces to provide for a comprehensive chemical, biological, explosives and nuclear radiation detection and reporting system for contraband and other chemical and nuclear materials of interest. The contents of U.S. Pat. No. 7,468,672 is hereby incorporated herein by reference in its entirety.

One or more embodiments of the nuclear radiation detector based on the present disclosure are able to be interfaced with an electronic security system or container tracking device such as those programmed for determinations of container breach, tracking the container, and communicating contraband detection data to appropriate authorities and databases.

Two radiation detectors are placed inside the container; each detector comprises one or more radiation sensors such as scintillation counters, semiconductor detectors and gaseous ionization sensors. One detector, the “background detector,” is placed in close proximity to the container wall or multiple container walls and is shielded such that it can only detect radiation originating from outside the container, i.e., background radiation that varies from place to place throughout the container transit. The second detector is situated such that it will detect radiation from inside and outside the container. The difference in the levels of detected radiation is then the level of radiation originating from inside the container, from either legitimate or illegal sources. Thus, variation in background radiation from a variety of sources is accounted for and does not interfere with the detection and identification of radiation from sources located inside the container. The method is used to aid government agencies in effecting rapid and secure flow of goods across national borders.

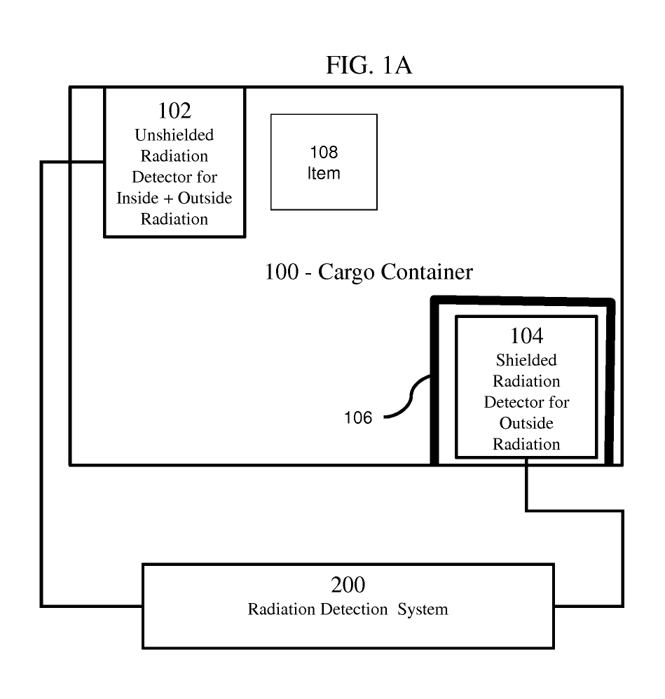

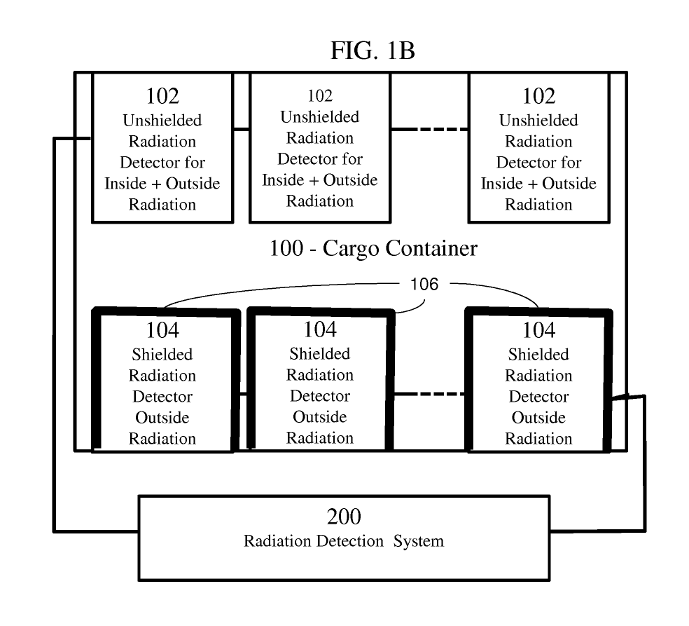

FIG. 1A is a high level block diagram of a container 100 comprising a pair of radiation detectors 102 and 104 as described herein. In at least one embodiment, the radiation detectors are scintillation counters. Radiation detector 102 is also referred to as an unshielded radiation detector. Radiation detector 104 is referred to as a background detector due to the position of the detector with respect to shielding material 106 forming a wall preventing the background detector from detecting potential radiation from within container 100. Radiation detector 104 is also referred to as a shielded radiation detector. Container 100 further comprises several other items 108 such as items to be shipped in the container 100. In at least some embodiments, more or less number of items 108 are within container 100.

In at least some embodiments, shielding material 106 shields background detector 104 on at least two sides from potential radiation emitted from within the container, e.g., from an item 108 within the container. In at least some embodiments, shielding material 106 shields background detector 104 on at least three sides from potential radiation. In at least some embodiments, shielding material 106 shields all but one side of background detector 104 from potential radiation.

In at least some embodiments, radiation detector 102 is not shielded from potential radiation emitted from within the container.

In at least some embodiments, radiation detector 102 is positioned wholly within container 100. In at least some embodiments, background detector 104 is positioned in a corner of container 100. In at least some embodiments, background detector 104 is positioned along an edge of a wall of container 100.

In at least some embodiments, radiation detector 102 and background detector 104 communicate via wired or wireless communication. In at least one embodiment, at least one of radiation detector 102 or background detector 104 comprises a computer system usable to perform the method of the present disclosure.

FIG. 1B is a high level block diagram of container 100 comprising a plurality of pairs of radiation detectors 102 and 104 as described according to another embodiment. Container 100 (FIG. 1B) comprises more than one pair of shielded and unshielded radiation detectors 102 and 104. Each of the sets of shielded and unshielded radiation detectors are communicatively coupled to radiation detection system 200. The dashed portion of the lines connecting the sets being indicative of additional radiation detectors in the configuration. In FIG. 1B the items 108 are omitted from within container 100 for clarity.

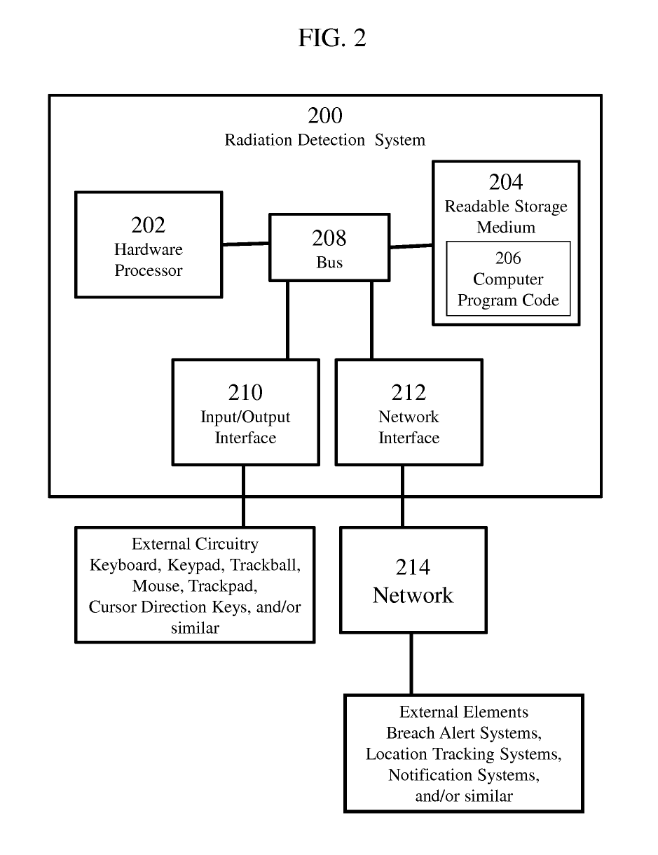

FIG. 2 is a high level functional block diagram of a computer system 200 usable in conjunction with an embodiment, also referred to as a radiation detection system 200. In at least one embodiment computer system 200 is a part of or connected with one or both of radiation detector 102 or background detector 104.

Radiation detection system 200 includes a hardware processor 202 and a non-transitory, computer readable storage medium 204 encoded with, i.e., storing, the computer program code, i.e., a set of executable instructions comprising a radiation detection process 206. Computer readable storage medium 204 is also encoded with instructions for interfacing with elements of radiation detection system 200. The processor 202 is electrically coupled to the computer readable storage medium 202 via a bus 208. The processor 202 is also electrically coupled to an I/O interface 210 by bus 208. A network interface 212 is also electrically connected to the processor 202 via bus 208. Network interface 212 is connected to a network 212, so that processor 202 and computer readable storage medium 204 are capable of connecting and communicating to external elements, e.g., breach alert systems, location tracking systems, notification systems, and similar, via network 212. In some embodiments, network interface 212 is replaced with a different communication path such as optical communication, microwave communication, inductive loop communication, or other suitable communication paths. The processor 202 is configured to execute the computer program code 206 encoded in the computer readable storage medium 202 in order to cause radiation detection system 200 to be usable for performing a portion or all of the operations as described.

In some embodiments, the processor 202 is a central processing unit (CPU), a multi-processor, a distributed processing system, an application specific integrated circuit (ASIC), and/or a suitable processing unit. In some embodiments, processor 202 is configured to generate radiation detection signals for transmitting to external circuitry via network interface 212.

In some embodiments, the computer readable storage medium 202 is an electronic, magnetic, optical, electromagnetic, infrared, and/or a semiconductor system (or apparatus or device). For example, the computer readable storage medium 202 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 202 includes a compact disk-read only memory (CD-ROM), a compact disk-read/write (CD-R/W), and/or a digital video disc (DVD).

In some embodiments, the storage medium 204 stores the computer program code 206 configured to cause radiation detection system 200 to perform the operations as described. In some embodiments, the storage medium 202 also stores information needed for performing the operations as described with respect to radiation detection system 200, such as radiation detector 102 detected radiation levels, background detector 104 detected radiation levels, and/or the difference between the detected radiation levels of the radiation detector and the background detector.

Radiation detection system 200 includes I/O interface 210. I/O interface 210 is coupled to external circuitry. In some embodiments, I/O interface 210 includes a keyboard, keypad, mouse, trackball, trackpad, and/or cursor direction keys for communicating information and commands to processor 202. In at least some other embodiments, I/O interface 210 is usable to couple the radiation detection system 200 to one or both of radiation detector 102 and/or background detector 104.

Radiation detection system 200 also includes network interface 212 coupled to the processor 202. Network interface 212 allows radiation detection system 200 to communicate with network 212, to which one or more other computer systems are connected. Network interface 212 includes wireless network interfaces such as BLUETOOTH, WIFI, WIMAX, GPRS, or WCDMA; or wired network interface such as ETHERNET, USB, or IEEE-1394.

Radiation detection system 200 is configured to receive information related to the detected radiation level from radiation detector 102 and/or background detector 104. The radiation level information is transferred to processor 202 via bus 208 to determine an adjusted radiation level based on removing the background detector 104 detected radiation level from the radiation detector 102 detected radiation level. The adjusted radiation level is then stored in computer readable medium 202.

In accordance with one or more embodiments of the present disclosure, rapid analysis of radiation detection data and information is neither required nor is rapid analysis desirable. At least one embodiment makes use of the advantage of long term analysis time periods being available for radioactivity analyses during transit of containers, analysis time periods of a few hours to several days. The long term transit times of cargo containers are utilized to: 1) to allow accumulation of measurements of contraband radiation in the enclosed spaces to levels that are more reliably detectable and 2) to improve sensitivity and specificity of the analysis process by continuously monitoring radiation levels both inside and outside the container throughout the in-transit time period. Utilization of the significant amounts of time that containers are in transit allows more sensitive and reliable measurements of nuclear radiation from contraband materials is a unique aspect of an embodiment according to the present disclosure for detection of nuclear contraband. Longer time periods for processing radiation measurements and analyzing nuclear radiation detector data results in more effective detections and suppression of false detections.

The results of the analyses are stored in electronic memory aboard an analysis and detection device. Appropriate embedded operational software enables the analysis and detection of radiation levels. In at least some embodiments, pertinent information concerning contraband is transmitted either directly or via satellite communications. In at least some embodiments, reports of the presence of contraband are provided to appropriate government and inspection officials at transportation chokepoints at any time throughout the transport of the container. In at least some embodiments, the system is configured to transmit security information along with GPS location whenever the container is in a position for satellite communications. In at least some embodiments, the device is able to be interfaced with other detection technologies such as chemical detectors and devices that might be used to detect breaches of the sealed container. When these detectors and breach detection devices are interfaced into a single system, nuclear radiation, chemical weapons of mass destruction, explosives, decaying plant and vegetable matter, concealed humans, and breaches of the container are detectable. In at least some embodiments, detection of any of these abnormalities is reported at any time throughout the transit time of the container whether the container is in the port of embarkation; in transit via air, land or sea; or in the port of disembarkation.

There are millions of shipping containers and cargo carriers in use in the world and many more millions of container and carrier uses per year. Inspection of cargo containers and carriers is time consuming and results in delays in timely movement of containers across national border crossings, through seaports, and through airports. A detailed inspection of a single cargo container for contraband substances can take hours to accomplish. Speeding of the inspection capability is a prime interest of governments around the world to provide timely and efficient interdiction. The method described in this patent application will facilitate the inspection process by indications of containers that are likely to contain contraband and, therefore, identify containers that should be inspected or to indicate containers that need not be inspected.

Technology exists in the form of small, unobtrusive, low power consumption, radiation detectors, for example scintillation counters, that have been incorporated into many types of nuclear radiation detection systems. The technology is routinely used by law enforcement and security personnel searching for concealed radioactive materials. In at least some embodiments, the mode of operating the presently disclosed detection device is modified for a particular application.

It is likely that nuclear radiation levels due to the presence of contraband in containers will be small because of radiation shielding that will be added to nuclear contraband. In at least some scenarios, reliable detection and analysis of such low levels of radiation requires significant amounts of time to perform. Such long analysis times, e.g., hours, results in better sensitivity and selectivity of the detector for determination of trace quantities of radioactive materials of interest as compared to prior approaches. In accordance with at least one embodiment, the analyses are performed while the container is in transit and the analyses are performed automatically, cheaply, and reliably without expenditure of extensive amounts of electrical power.

Through the use of appropriate software, the output of one of the nuclear radiation detectors is interfaced with other detection technologies such as chemical, biological and explosive detectors and devices used to detect unauthorized entry of the sealed container in at least some embodiments. In at least some embodiments, reports of a container's history and accountability include a probability of nuclear contraband chemical in the container. In at least some embodiments, the system is configured to transmit security information along with GPS location whenever the container is in a position for satellite communications.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A device for detecting radioactive contraband located in confined spaces of shipping containers, storage containers and/or other cargo containers and secure spaces, the device comprising:
(a) one or more shielded radiation detectors inside a shipping container for detecting nuclear radiation originating outside the container, the one or more shielded radiation detectors being shielded such that radiation originating from inside the container is not detected by the one or more shielded radiation detectors;
(b) one or more unshielded radiation detectors inside the container for detecting nuclear radiation originating from both inside and outside the container;
(c) a radiation detection system communicatively coupled with the one or more shielded radiation detectors and the one or more unshielded radiation detectors, the radiation detection system comprising:
a processor for executing instructions; and
a computer readable storage medium storing instructions which, when executed by the processor, cause the processor to:
generate a background radiation level signal based on input from the one or more shielded radiation detectors,
generate a total radiation level signal based on input from the one or more unshielded radiation detectors,
generate an adjusted radiation level signal based on subtracting the background radiation level signal from the total radiation level signal, and
analyze the spectroscopy energy distribution and intensity of the adjusted radiation level signal to allow identification of the radioisotope or radioisotopes that emit the adjusted radiation level signal.

2. The device as claimed in claim 1, wherein the computer readable storage medium stores the container manifest and instructions which, when executed by the processor, cause the processor to:
analyze the container manifest to determine if radiation from inside the container is due to declared cargo in the container manifest or that radiation from inside the container is due to cargo not in the container manifest.

3. The device as claimed in claim 1, further comprising a network interface for reporting the potential presence of contraband to government agencies to effect rapid and secure flow of goods across national borders.

4. The device as claimed in claim 1, further comprising a network interface for electronic interfacing the radiation detection system with one or more chemical contraband detection systems.

5. The device as claimed in claim 1, further comprising a network interface for interfacing the radiation detection system with electronic security systems for one or more of determination of container breach, tracking the container, and/or communicating contraband detection data to appropriate authorities and databases.

6. The device as claimed in claim 1, further comprising a network interface for interfacing the radiation detection system and one or more chemical contraband detection systems with electronic security systems for one or more of determination of container breach, tracking the container, and/or communicating contraband detection data to appropriate authorities and databases.

7. The device as claimed in claim 1 wherein the device is operable during the transit time of the container.

8. The device as claimed in claim 7, wherein transit time comprises one or more of the time period during stuffing and sealing, the time period in ports of embarkation, the time period in transit by air, land or sea, the time period in port of disembarkation, and the time period during transport of the container to final destination.

9. The device as claimed in claim 1, further comprising instructions for processing nuclear radiation detection data to detect and identify potential contraband by comparing accumulated radiation measurements to previously determined databases of low level radiation emanating from legal cargo sources.

10. A method of determining potential contraband presence in a shipping container, the shipping container comprising a radiation detection system communicatively coupled with an unshielded radiation detector and a shielded radiation detector, the shielded radiation detector shielded to minimize the detection of radiation originating from inside the container by the shielded radiation detector, the radiation detection system comprising a processor and a computer readable storage medium storing instructions which, when executed by the processor, cause the processor to perform the method, the method comprising:
generating a background radiation level signal based on input from the one or more shielded radiation detectors,
generating a total radiation level signal based on input from the one or more unshielded radiation detectors,
generating an adjusted radiation level signal based on subtracting the background radiation level signal from the total radiation level signal, and
analyzing the spectroscopy energy distribution and intensity of the adjusted radiation level signal to allow identification of the radioisotope or radioisotopes that emit the adjusted radiation level signal.

11. The method as claimed in claim 10, further comprising:
analyzing a container manifest to determine if radiation from inside the container is due to declared cargo in the container manifest or that radiation from inside the container is due to cargo not in the container manifest.

12. The method as claimed in claim 10, wherein the method is performed during the transit time of the shipping container.

13. The method as claimed in claim 10, wherein transit time comprises one or more of the time period during stuffing and sealing, the time period in ports of embarkation, the time period in transit by air, land or sea, the time period in port of disembarkation, and the time period during transport of the container to final destination.
